(19) United States
(12) Patent Application Publication
(10) Pub. No.: US 2006/0232185 A1
(43) Pub. Date: Oct. 19, 2006

(54) Assembly comprising a cathodoluminescent screen and protective cover therefor

(76) Inventor: Stéphane Ducasse, Chateauroux (FR)

Correspondence Address: FOLEY & LARDNER LLP, 777 EAST WISCONSIN AVENUE, MILWAUKEE, WI, 53202-5306, US

(21) Appl. No.: 10/561,355

(22) PCT Filed: Jun. 20, 2003
(86) PCT No.: PCT/FR03/01904

§ 371 Date: Apr. 17, 2006

(51) Int. Cl. H01J 63/04; H01J 1/62; H01J 1/18

(52) U.S. Cl. 313/495; 313/238

(57) ABSTRACT

The invention pertains to the assembly of a cathodo-luminescent display, comprising at least one anode on which a phosphor material has been deposited, and of its protective shroud, characterized in that the shroud is made from a plastic comprising coloured pigments embedded in the mass so as to form a colour filter for the said display, the phosphor material and the shroud coloration pigments being chosen so as to give a determined colorimetric rendition, the shroud moreover exhibiting an attenuated transmission factor. The light transmission factor is between 5 and 20%.

### CROSS-REFERENCE TO RELATED PATENT APPLICATIONS

The present Application is a National Stage of Application PCT/FR03/01904 entitled, “Assembly Comprising a Cathodoluminescent Screen and a Protective Cover Therefor” filed on Jun. 20, 2003 which published under PCT Article 21(2) on Jan. 27, 2005 as WO 2005/008714 A1 in the French language, the disclosure of which is incorporated herein by reference in its entirety.

The invention relates to the field of information display, in particular in a vehicle dashboard, by means of a cathodo-luminescent display screen, also referred to as a VFD standing for Vacuum Fluorescent Display.

A cathodo-luminescent display such as a cathode-ray tube, employs an electron beam exciting a layer of phosphor particles. Thus, a basic structure comprises a cathode, a grid and an anode that are sealed inside a glass envelope in which a vacuum is made. The cathode is brought by heating to a temperature sufficient to cause thermoelectronic emission. The grid is composed of a metal lattice and controls by polarization the cathodic current to the anode. The anode is formed of segments or dots covered with a layer of phosphors which emit light under the action of the electrons. It is situated at the rear of the grid with respect to the emission of electrons.

The images or characters which are apt to appear on the display are therefore predefined by the shape of the segments or of the dots of the anode. The principal characteristics of this type of display are that of a field-emission display, namely:

very high contrast,

isotropic (or “Lambertian”) emission, hence a large viewing angle,

very short response time,

high brightness making it possible to observe them even in full daylight,

good resistance to high temperatures, and

relatively low manufacturing costs.

The colour (the wavelength) of the luminous emission is determined by the nature of the phosphor. A range of phosphors whose radiation spectrum covers the visible spectrum is used. For example a phosphor of type ZnS:Zn emits a radiation between 400 and 600 nm with a maximum at 464 nm or else that of type ZnO:Zn emits a radiation between 400 and 700 nm with a maximum at 505 nm.

In application within the automotive field in particular, the display is inserted into a housing inside the dashboard, behind a translucent shroud. This translucent shroud is usually tinted with a “smoked” colour so as to exhibit an opaque, dark surface when it is not illuminated. A light transmission factor of as low as 7.5% is sufficient. Additionally, in order to obtain a predetermined colorimetric rendition, satisfying the constraints of use within this field, an appropriate colour filter dependent on the phosphor of the display is disposed on the glass pane at the front, between the display and the shroud.

The applicant has sought to improve the overall structure so as to render the setup simpler.

The applicant has solved this problem with an assembly of a cathodo-luminescent display, comprising at least one anode on which a phosphor material has been deposited, and of its protective shroud, characterized in that the shroud is made from a plastic comprising coloured pigments embedded in the mass so as to form a colour filter for the said display, the phosphor material and the shroud coloration pigments being chosen so as to give a determined colorimetric rendition, the shroud moreover exhibiting an attenuated transmission factor.

In accordance with a characteristic, the shroud exhibits a light transmission factor of between 5 and 20%, preferably between 5 and 10% especially between 5.5 and 7.5%.

The invention is described hereinbelow in greater detail with reference to the drawings in which,

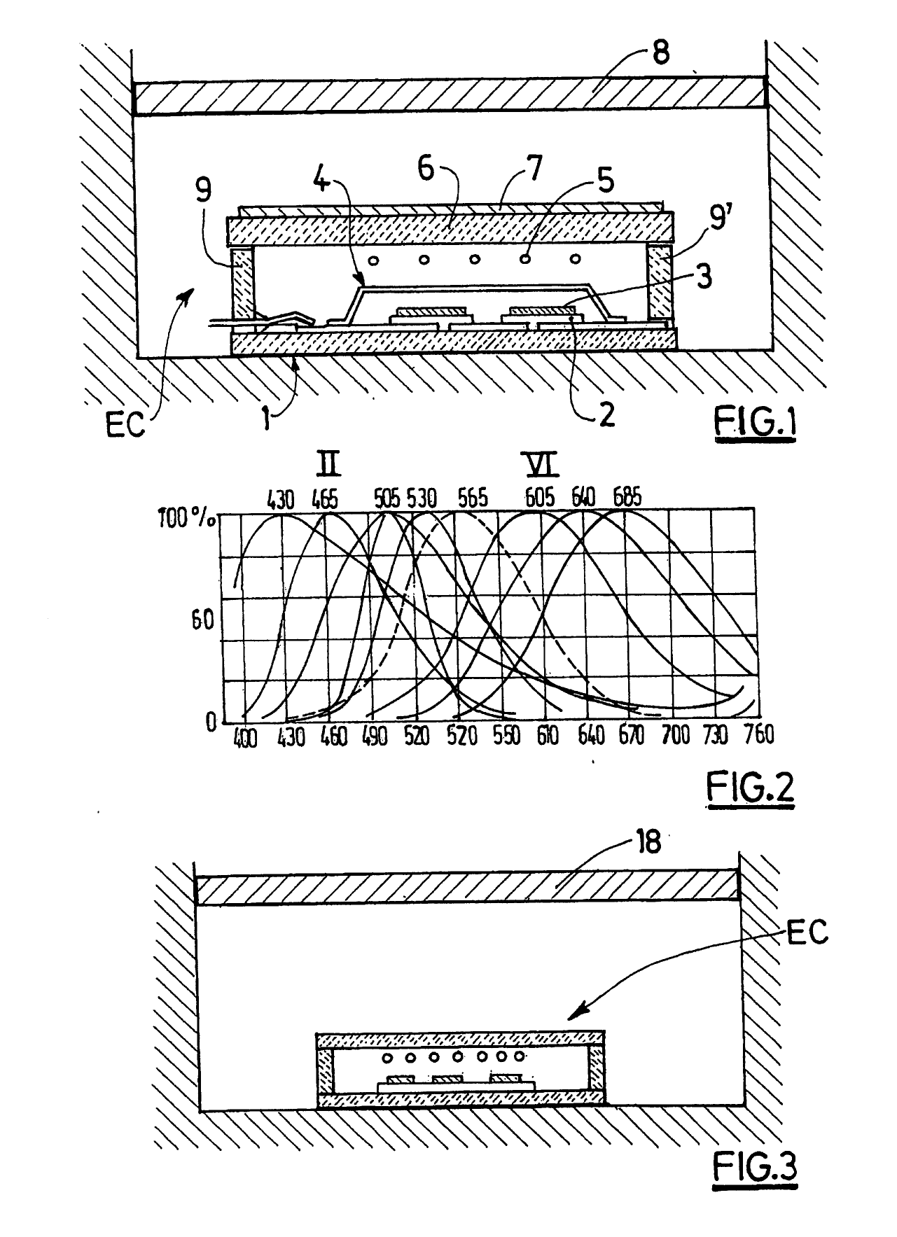

FIG. 1 represents a cathodo-luminescent display,

FIG. 2 shows the spectral distribution of the phosphors,

FIG. 3 represents a setup according to the invention.

Represented in FIG. 1 is the diagram of a cathodo-luminescent display EC with its various components. It comprises a glass plate 1 on which is disposed the layer of electrodes forming the anodes the latter are covered with a phosphor material 3. The shape of the electrodes is constituted by elements in the shape of segments or else dots. It is these elements which, combined together, form the alphanumeric characters or the figures desired. The grid 4 is interposed between the anode 2 and the filaments of the cathode 5. The latter takes the form of slender rods of tungsten covered with an alkaline metal oxide.

A second glass plate 6 forms the front pane visible by an observer. The enclosure formed by the two glass plates and two transverse spacers 9 and 9′ is evacuated. When a voltage is created between the electrodes, the electrons activate the phosphor material 3 which emits photons through the front plate 6.

Represented in FIG. 2 is the spectral distribution of the light emitted by the various phosphors that are commonly used for this application. The abscissa indicates the wavelength and the ordinate the relative percentage of light emitted. For example, the phosphor 11 emits a radiation at a wavelength of between 400 and 580 nm with a peak at 465 nm.

According to the prior art, by selecting the phosphor material and by disposing a film 7 forming an appropriate coloured filter on the front plate, an image exhibiting any desired colorimetric rendition is obtained.

In an automotive vehicle, the display is generally disposed inside a housing closed on the rear and the sides. The housing is masked on its facade by a translucent plate 8 whose luminous transmission factor is low enough for the display, when it is not emitting, not to be visible from the cabin of the vehicle. The plate 8 of the facade is made of “smoked” plastic. Its transmission factor is less than 20%.

Represented in FIG. 3 is an embodiment according to the invention. The display is the same as above with the difference that it comprises no film filtering the light emitted. This function is undertaken by the shroud 18 which, as in the above embodiment has a smoked appearance with a luminous transmission power of between 5 and 20% but which, in addition and in accordance with the invention, forms a coloured filter.

Advantageously, the translucent shroud is made from a plastic such as polymethyl methacrylate (PMMA).

The appropriate coloured pigments have been incorporated into the material. The mode of manufacture is known in the field of the manufacture of plastic articles. Appropriate pigments may for example be mixed with granules of plastic, here PMMA, before extrusion so as to obtain a suitably coloured material before the forming operation.

The pigments have been selected in conjunction with the phosphor of the display so that the colorimetric rendition is fixed at a determined value. In particular, the pigments are chosen so that the colour of the VFD viewed through the filter exhibits a dominant wavelength of 490 nm.

A phosphor which emits a blue-green tinted light is used for this purpose, and filtering elements attenuating the green wavelengths have been incorporated into the shroud. The effect of the assembly is thus to render a more saturated blue colour.

Of course, other combinations are possible without departing from the scope of the invention.

1. Assembly of a cathodo-luminescent display, comprising at least one anode on which a phosphor material has been deposited, and of its protective shroud, characterized in that the shroud is made from a plastic comprising coloured pigments embedded in the mass so as to form a colour filter for the said display, the phosphor material and the shroud coloration pigments being chosen so as to give a determined colorimetric rendition, the shroud moreover exhibiting an attenuated transmission factor.

2. Shroud according to claim 1 exhibiting a light transmission factor of between 5 and 20%.

3. Shroud according to claim 2 exhibiting a light transmission factor of between 5.5 and 7.5%.
